(19) United States
(12) Patent Application Publication
(10) Pub. No.: US 2003/0110983 A1
(43) Pub. Date: Jun. 19, 2003

(54) Earthquake resistant concrete using three-dimensional metal reinforcing aggregate

(76) Inventor: Yukinori Hayashi, Ibi-gun (JP)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 09/936,532

(22) PCT Filed: Jan. 15, 2001
(86) PCT No.: PCT/JP01/00199

(30) Foreign Application Priority Data
Jan. 15, 2001 (JP) 2000-8137

(51) Int. Cl. C04B 14/48

(52) U.S. Cl. 106/644; 106/732

(57) ABSTRACT

The present invention uses a three-dimensional metal reinforcing aggregate as an aggregate in producing a common ready-mixed concrete according to its object of use in producing the ready-mixed concrete and a mortar. Since it is the three-dimensional metal reinforcing aggregate, it is a technique to enhance the external pressure, internal pressure and tensile strength when the ready-mixed concrete is hardened and solidified. Since the three-dimensional metal reinforcing aggregate is forced into between an aggregate and an aggregate in the ready-mixed concrete, the aggregate and the aggregate are further bound, thereby enhancing the internal pressure, the external pressure and the tensile strength. For example, if split, crack and the like is generated on the concrete body near the cold joint of the placed concrete, the conventional concrete body leads to drop thereof and causes an accident. However, with the concrete body using the inventive three-dimensional metal reinforcing aggregate as the aggregate, even if the crack or the like is generated thereon, the three-dimensional metal reinforcing aggregate is coupled and connected with a variety of aggregates in the concrete body. Therefore, even if the split, crack or the like is generated thereon, it never leads to the drop.

Consequently, it is a technique of high strength that can prevent the accident of concrete lump drop due to the cold joint and that also intends safety for a variety of structure of public works and buildings. It is an earthquake-resisting concrete that can construct structures such as bridges, dams, tunnels, buildings, airports, harbors and the like.

It is characterized by using and mixing and kneading a three-dimensional metal reinforcing aggregate as an aggregate in manufacturing a ready-mixed concrete.

### DETAILED DESCRIPIION OF THE INVENTION

1. Technical Field to which the Invention Belongs

The present invention relates to an aggregate for public works and buildings or for producing common ready-mixed concrete, is a technique for enhancing strength, hardness, internal pressure, external pressure and tensile strength of a concrete body, is a manufacturing technique for enhancing the strength, hardness, internal pressure, external pressure and tensile strength of the concrete body when the ready-mixed concrete is hardened and transferred into the concrete body by using a three-dimensional metal reinforcing aggregate, is a new technique relating to prevention of a concrete lump drop of a concrete construction such as concrete joints due to chipping or cracking and is a new technique relating to a high-strength concrete body structure for a construction such as bridges, dams, tunnels, buildings, airports, harbors and so on.

2. Prior Art

Conventional concrete for public works or buildings are classified into three categories, i.e. a heavyweight concrete, a normal concrete and a lightweight concrete, depending on a category, quality and class of the concrete and a category of an aggregate used in the concrete. JASS5 classifies it as shown in Table 1, depending on combination of the normal concrete, the lightweight concrete and a category of a coarse or a fine aggregate used therein.

TABLE 1
CATEGORY OF CONCRETE (JASS 5)

| | | Used aggregate | |
|---|---|---|---|
| Category of concrete | | Coarse aggregate | Fine aggregate |
| Heavyweight concrete | | Heavyweight | Heavyweight |
| | | aggregate | aggregate, |
| | | | sand or crushed sand |
| Normal | Gravel | Gravel | Sand or crushed sand |
| concrete | aggregate | | |
| | concrete | | |
| | Crushed stone | Crushed stone | Sand or crushed sand |
| | concrete | | |
| | Blast furnace | Blast furnace slag | Sand or crushed sand |
| | slag crushed | crushed stone | |
| | stone concrete | | |
| Lightweight | 1st category | Artificial | Sand or crushed |
| concrete | | lightweight | sand |
| | | aggregate | |
| | 2nd category | Artificial | Artificial |
| | | lightweight | lightweight |
| | | aggregate | aggregate or Artificial |
| | | | lightweight aggregate |
| | | | added with sand or |
| | | | crushed sand |
| | 3rd category | Natural | Sand or crushed sand |
| | | lightweight | |
| | | aggregate | |
| | | or by-product | |
| | | lightweight | |
| | | aggregate | |
| | | (Classification | |
| | | according to | |
| | | strength: | |
| | | 300 or more (1)) | |
| | 4th category | Natural | Sand or crushed sand |
| | | lightweight | |
| | | aggregate or | |
| | | by-product | |
| | | lightweight | |
| | | aggregate | |
| | | (Classification | |
| | | according to | |
| | | strength: | |
| | | 200 or more (1)) | |
| | 5th category | Natural | Natural lightweight |
| | | lightweight | aggregate or |
| | | aggregate or | by-product |
| | | by-product | lightweight aggregate |
| | | lightweight | (Classification |
| | | aggregate | according to strength: |
| | | (Classification | 200) |
| | | according to | |
| | | strength: 200) | |

(Note) (1) is based on JIS A 5002 (Structural concrete aggregate)

TABLE 2
SPECIFICATION ACCORDING TO CLASS OF QUALITY OF CONCRETE (JASS 5)

| Standard strength in design of concrete Fe (kg/cm₂) | | | | |
|---|---|---|---|---|
| Normal concrete | | | | |
| | Blast | | | |
| Gravel | furnace | Lightweight concrete | | |
| and | slag | 1st | Applied class of specification | Reference |

| | | | | | | | | | |
|---|---|---|---|---|---|---|---|---|---|
| Quality | crushed | crushed | Category | | | | Specification | Specification | (example of |
| class of | stone | stone | and 2nd | 3rd | 4th | 5th | about | about | structure as |
| concrete | concrete | concrete | category | category | category | category | material | construction | object of use) |

| | | | | | | | | | |
|---|---|---|---|---|---|---|---|---|---|
| High | 270 or | — | 240 or | — | — | | 1st class | 1st category | Building frame |
| grade | more | | more | | | | | | made of RC or |
| | 240 | | 225 | | | | | | SRC needing |
| | 225 | | 210 | | | | | | concrete of |
| | 210 | | | | | | | | particularly |
| | | | | | | | | | high reliability |
| Com- | 240 | 240 | 225 | 210 | 135 | | 2nd class | 2nd category | Building frame |
| mon | 225 | 225 | 210 | 180 | 120 | | | | made of |
| grade | 210 | 210 | 180 | 150 | | | | | normal RC or |
| | 180 | 180 | 150 | | | | | | SRC |
| | 150 | 150 | | | | | | | Footing made |
| | | | | | | | | | of concrete |
| | | | | | | | | | blocks, |
| | | | | | | | | | circumferential |
| | | | | | | | | | girder, slab |
| | | | | | | | | | and angle post |
| Low | 135 | 135 | 135 | 135 | 90 | 90 | 3rd class | 3rd category | Footing of |
| cost | | | | | | | | | wooden |
| | | | | | | | | | buildings, |
| | | | | | | | | | small-sized |
| | | | | | | | | | gate and wall, |
| | | | | | | | | | petty structure |
| | | | | | | | | | not for |
| | | | | | | | | | residence, |
| | | | | | | | | | simple |
| | | | | | | | | | machine table |

As shown in Table 2, the quality of the concrete is classified into three grades: high grade, common grade and low cost so as to be used according to a category of a building or importance.

RC specifications properly use them according to the importance, however, have no special classification.

According to a quality specification of an aggregate, generally required for the concrete are those which are stiff and hard, which have good grain shape and grain size, which are clean and pure without hazardous substances and which are durable and fireproof.

With respect to the quality of the aggregate regulated by JASS5RC specifications JIS or the like, particularly, JASS5 classifies the quality of the aggregate into the first class, the second class and the third class according to the quality and class of the concrete.

TABLE 3
QUALITY REGULATION OF AGGREGATE OF JASS 5
(a) Quality of gravel, sand and crushed stone

| | | | | Soild volume | | Content of | | |
|---|---|---|---|---|---|---|---|---|
| Item | | | | percentage for | | materials | | |
| | Class of | Absolute | | shape | Content | passing 75 μm | | |
| | specification | dry | Water | determination | of clay | standard sieve | | |
| | of | specific | absorption | (crushed stone) | lumps | in aggregate | Organic | Salinity |
| Category | material | gravity | (%) | (%) | (%) | (%) | impurities | (%) |
| Gravel | 1st class | 2.5 or | 2.0 or less | 57 or more | 0.25 or | 1.0 or less (1) | — | — |
| and | | more | | | less | | | |
| crushed | 2nd class | 2.5 or | 3.0 or less | 55 or more | 0.25 or | 1.0 or less (1) | — | — |
| stone | | more | | | less | | | |
| | 3rd class | 2.4 or | 4.0 or less | 53 or more | 0.5 or | — | — | — |
| | | more | | | less | | | |
| Sand | 1st class | 2.5 or | 3.0 or less | — | 1.0 or | 2.0 or less | Color of | 0.04 or |
| | | more | | | less | | test | less |
| | 2nd class | 2.5 or | 3.5 or less | — | 1.0 or | 3.0 or less | solution | 0.1 or |
| | | more | | | less | | being not | less |
| | 3rd class | 2.4 or | 4.0 or less | — | 2.0 or | 5.0 or less | deeper | 0.1 or |
| | | more | | | less | | than | less |
| | | | | | | | standard | |
| | | | | | | | solution | |

(b) Quality of blast furnace slag crushed stone

| | Classification | | | |
|---|---|---|---|---|
| | according to JIS | | | |
| | A 5011 | | | |
| | (absolute dry | | Content of | |
| | specific gravity, | Solid volume | materials | Permissible |
| Item | water | percentage for | passing 75 μm | range of |
| Class of | absorption and | shape | standard sieve | variation of |
| specification of | weight of unit | determination | in aggregate | fineness |
| material | volume) | (%) | (%) | modulus |
| 2nd class | A or B (2) | 55 or more | 5 or less | ±0.3 |
| 3rd class | A or B | 53 or more | — | ±0.3 |

(c) Quality of lightweight aggregate

| | | | | | Division | | | |
|---|---|---|---|---|---|---|---|---|
| | | | | | according | | | Floating |
| | | Division | | | to | | | particles in |
| | | according | Division | | absolute | | | lightweight |
| | | to | according | | dry | Permissible range of | | coarse |
| Class of | Division | compressive | to soide | | specific | variation of fineness | | aggregate |
| specification | according to | strength | volume | | gravity of | modulus | | (%) |
| of | classification | as concrete | percentage | Stability (3) | aggregate | Coarse | Fine | Coarse |
| material | (3) | (3) | (3) | (%) | (3) | aggregate | aggregate | aggregate |
| 1st class | Artificial | 400 | A | — | H | ±0.30 | ±0.15 | 10 or less |
| | | 300 | | | M | | | |
| 2nd class | Artificial | 400 | A | 12 or less | H | | (4) | |
| | | | | (4) | | | | |
| | Natural | 300 | B | Artificial is | M | ±0.30 | ±0.15 | 10 or less |
| | By-product | 200 | | eliminated | | | | |
| 3rd class | Artificial | 400 | A | 20 or less | H | Artificial | Artificial | |
| | Natural | 300 | B | Artificial is | M | ±0.30 | ±0.15 | |
| | By-product | 200 | | eliminated | L | | | |

(Note) (1) In case of crushed stone, it is decided as 1.5% or less when those lost in the decantation test are crushed stone elements.
(Note) (2) In case a design strength of the blast furnace slag crushed stone concrete is 225 kg/cm2 or more, the classification B is used.
(Note) (3) According to JIS A 5002 (structural lightweight concrete aggregate)
(4) In case of the natural or by-product lightweight aggregate having the design strength of 180 kg/cm2 or less, the stability is decided as 20% or less and the variation permissible range of the fineness modulus of the fine aggregate is decided as ±0.25.

A size of a sieve to be used is regulated by the “sieve analysis of aggregate” of JIS (A1102).

Fine aggregate: 0.15, 0.3, 0.6, 1.2, 2.5, 5 and 10 mm.

Coarse aggregate: 2.5, 5, 10, 15, 20, 25, 30, 40, 50, 60, 80 and 100 mm.

JIS (A530S) of the ready-mixed concrete shown in Table 3 has accompanying documents and provides the category and the quality of the aggregate for public works and for buildings, respectively. The one for the buildings in the RC specifications for the public works is regulated in the same way as the second class of JASS 5.

An approximate relation between various properties of these aggregates and performance of the concrete is shown as in Table 4 as a list.

TABLE 4
An approximate relation between the various properties of these aggregates and
the performance of the concrete is shown as in the following Table as the list.
Various properties of aggregate and capability of concrete

| Performance | Concrete before solidified | | | | | Hardened concrete | | | |
|---|---|---|---|---|---|---|---|---|---|
| of concrete | | Separa- | Air | Floccula- | Heat | | | | Dry |
| Property of | Work- | tion/ | quan- | tion | Genera- | Specific | | Young's | contrac- |
| aggregate | ability | Breezing | tity | Hardening | tion | gravity | Strength | modulus | tion |
| Chemical | | | | ◯ | | ◯ | ◯ | | |
| component | | | | | | | | | |
| Specific | | ◯ | | | | ⊚ | ◯ | ◯ | |
| gravity | | | | | | | | | |
| Water | ◯ | ◯ | | | | | ◯ | | ⊚ |
| absorption | | | | | | | | | |
| Strength | | | | | | | ⊚ | ◯ | |
| Grain | ⊚ | ⊚ | ◯ | | | ⊚ | ◯ | | ◯ |
| shape, grain | | | | | | | | | |
| size | | | | | | | | | |
| maximum | | | | | | | | | |
| size | | | | | | | | | |
| Weight of | ◯ | ◯ | | | | | ◯ | | ◯ |
| unit volume, | | | | | | | | | |
| solid volume | | | | | | | | | |
| percentage | | | | | | | | | |
| Durability | | | | | | | ◯ | | |
| (Stability) | | | | | | | | | |
| Abrasion | | | | | | | ◯ | | |
| Resistance | | | | | | | | | |
| Fire | | | | | | | | | |
| resistance | | | | | | | | | |
| Heat | | | | | ⊚ | | | | |
| conduction, | | | | | | | | | |
| thermal | | | | | | | | | |
| expansion | | | | | | | | | |
| Organic | | | | ⊚ | | | ◯ | | |
| impurities | | | | | | | | | |
| Content of | ◯ | ◯ | ◯ | ◯ | | | ◯ | | ⊚ |
| materials | | | | | | | | | |
| passing | | | | | | | | | |
| 75 μm | | | | | | | | | |
| standard | | | | | | | | | |
| sieve in | | | | | | | | | |
| aggregate | | | | | | | | | |
| Salinity | | | | ◯ | | | | | ◯ |
| Clay lumps, | | | | | | ◯ | ⊚ | ◯ | ◯ |
| soft stone | | | | | | | | | |
| pieces | | | | | | | | | |

| | | Hardened concrete | | | | | | | |
|---|---|---|---|---|---|---|---|---|---|
| Performance | Ab- | | | Anti- | Fric- | | Chemi- | Radioactive | |
| of concrete | normal | Water- | Neutraliza- | freezing | tion | Fire | cals | rays | Heat |
| Property of | expan- | tight- | tion | melting | resis- | resis- | resis- | shielding | insula- |
| aggregate | sion | ness | (iron rust) | ability | tance | tance | tance | ability | tion |
| Chemical | ⊚ | | ◯ | | | ◯ | ⊚ | ◯ | ◯ |
| component | | | | | | | | | |
| Specific | | | ◯ | | | | | ⊚ | ⊚ |
| gravity | | | | | | | | | |
| Water | | ◯ | ◯ | ⊚ | | | | | ◯ |
| absorption | | | | | | | | | |
| Strength | | | | ◯ | ⊚ | | | | |
| Grain | | ⊚ | ◯ | | | | | | |
| shape, grain | | | | | | | | | |
| size | | | | | | | | | |
| maximum | | | | | | | | | |
| size | | | | | | | | | |
| Weight of | | ⊚ | ◯ | | | | | | |
| unit volume, | | | | | | | | | |
| solid volume | | | | | | | | | |
| percentage | | | | | | | | | |
| Durability | | ◯ | ◯ | ⊚ | | | | | |
| (Stability) | | | | | | | | | |
| Abrasion | | | | | ⊚ | | | | |
| Resistance | | | | | | | | | |
| Fire | | | | | | ⊚ | | | |
| resistance | | | | | | | | | |
| Heat | | | | | | ◯ | | | |
| conduction, | | | | | | | | | |
| thermal | | | | | | | | | |
| expansion | | | | | | | | | |
| Organic | | | | | | | | | |
| impurities | | | | | | | | | |
| Content of | | ◯ | | ◯ | ◯ | | | | |
| materials | | | | | | | | | |
| passing | | | | | | | | | |
| 75 μm | | | | | | | | | |
| standard | | | | | | | | | |
| sieve in | | | | | | | | | |
| aggregate | | | | | | | | | |
| Salinity | | | ⊚ | | | | ◯ | | |
| Clay lumps, | | ◯ | | ◯ | ⊚ | | | | |
| soft stone | | | | | | | | | |
| pieces | | | | | | | | | |

JIS A 5002 Aggregate for structural lightweight concrete
JIS A 5004 Crushed sand for concrete
JIS A 5005 Crushed stone for concrete
JIS A 5010 Blast furnace slag fine aggregate for concrete
JIS A 5011 Blast furnace slag fine aggregate for concrete
⊚ Having close relation
◯ having relation

Problem that the Invention is to Solve

It is required for the conventional concrete structure in public works and buildings to reconsider the strength, hardness, internal pressure, external pressure, anti-earthquake design, because of the incident of Great Hanshin Earthquake followed by Turkey Earthquake and Taiwan Earthquake. It is a subject of preparation for earthquake all over the world. In these years, there take place troubles in succession or an accident such as the one of Sanyo Shinkansen in Fukuoka Prefecture in which a concrete lump flaked off. The accident happened at Fukuoka tunnel in which the concrete lump hit directly the Hikari of Shinkansen and is really an important accident since the Shinkansen started.

The breakage of Shinkansen dating from the drop of the concrete lump is a big problem leading to a serious accident. It was followed by an accident of Japanese Railway Hokkaido in which a concrete body dropped in a tunnel, for example. They are very serious problems for tunnels of the railroad, the expressway and each of other roads. It is not supposed that the concrete flakes off in the tunnel. Experts have not predicted that there was a flaking accident at the joint or cold joint that was produced due to interruption of placing work of the concrete body or the like. It has not been listed as a matter needing special attention in tunnel checking essentials.

However, standard specifications for public works of the old National Railroad at the time of constructing Sanyou Shinkansen calls attention so that no troubles like the cold joint happen when executing the works. The cold joints were found at 2049 points of a front in nationalwide simultaneous checks.

Tunnels of the expressways, railroads and every roads of the national highways were checked. Its solution plan could not be found out. It is urgently needed to develop a new concrete body that has high internal pressure, external pressure and tensile strength. At the same time, it is also urgently needed to develop concrete aggregate.

Then, the inventor made a variety of examinations and experiments and created an invention of a three-dimensional metal reinforcing aggregate as a new aggregate that is related to prevention of drop of concrete lumps due to concrete joints. It is a technique that uses the three-dimensional reinforcing aggregate having an x-axis dimension, a y-axis dimension and a z-axis dimension as an aggregate of a concrete, thereby manufacturing a concrete body that is excellent in the internal pressure, the external pressure, the strength, the hardness and the tensile strength when a ready-mixed concrete is hardened and transferred into the concrete body. He developed a new technique of high strength or a three-dimensional metal reinforcing aggregate concrete body that can construct bridges, dams, tunnels, buildings, airports, harbors and so on. (This three-dimensional metal reinforcing aggregate has a three-dimensional shape of a curly and/or waved one, so that it is excellent in absorbing performance of electromagnetic waves.)

Means to Solve the Problem

The present invention uses a three-dimensional metal reinforcing aggregate as an aggregate in producing a common ready-mixed concrete, while mixing and kneading it therein, according to its object of use in producing the ready-mixed concrete and a mortar. Since it is the three-dimensional metal reinforcing aggregate, it is a technique to enhance the external pressure, internal pressure and tensile strength when the ready-mixed concrete is hardened and solidified. Since the three-dimensional metal reinforcing aggregate is forced into between an aggregate and an aggregate in the ready-mixed concrete, the aggregate and the aggregate are further bound, thereby enhancing the internal pressure, the external pressure and the tensile strength. For example, if split, crack and the like is generated on the concrete body near the cold joint of the placed concrete, the conventional concrete body leads to drop thereof and causes an accident. However, with the concrete body using the inventive three-dimensional metal reinforcing aggregate as the aggregate, even if the crack or the like is generated thereon, the three-dimensional metal reinforcing aggregate is coupled and connected with a variety of aggregates in the concrete body. Therefore, even if the split, crack or the like is generated thereon, it never leads to the drop.

Consequently, it is a technique of high strength that can prevent the accident of concrete lump drop due to the cold joint and that also intends safety for a variety of structure of public works and buildings. It is an earthquake-resisting concrete that can construct structures such as bridges, dams, tunnels, buildings, airports, harbors and the like.

Embodiments of the Invention

Described referring to FIG. 1 are a shape of a three-dimensional metal reinforcing aggregate according to an embodiment example of the present invention and a shape of an aggregate of an x-axis dimension, a y-axis dimension and a z-axis dimension according to a winding manufacturing work by a rotational shaft.

First Embodiment

A (three sides processed) three-dimensional metal reinforcing aggregate characterized by comprising a three-dimensional I-shape/reversed-V-type that is made by processing a shape of a steel wire plated with zinc or a stainless steel wire having a diameter of 1 millimeter to 6 millimeter and a length of a side of 1 centimeter to 6 centimeter into three sides of an I-shape type, 90 degrees, 80 degrees, 70 degrees, 60 degrees, 50 degrees, 40 degrees, 30 degrees, 20 degrees or 10 degrees and a rotational shaft.

Second Embodiment

A (four sides processed) three-dimensional metal reinforcing aggregate characterized by comprising a three-dimensional L-shape/reversed-V-type that is made by processing a shape of a steel wire plated with zinc or a stainless steel wire having a diameter of 1 millimeter to 6 millimeter and a length of a side of 1 centimeter to 6 centimeter into four sides of an L-shape type, 90 degrees, 80 degrees, 70 degrees, 60 degrees, 50 degrees, 40 degrees, 30 degrees, 20 degrees or 10 degrees and a rotational shaft.

Third Embodiment

A three-dimensional V-shape/reversed-V-type that is made by processing a shape of a steel wire plated with zinc or a stainless steel wire having a diameter of 1 millimeter to 6 millimeter and a length of a side of 1 centimeter to 6 centimeter into four sides of a V-shape type, 90 degrees, 80 degrees, 70 degrees, 60 degrees, 50 degrees, 40 degrees, 30 degrees, 20 degrees or 10 degrees and a rotational shaft.

Fourth Embodiment

A three-dimensional N-shape-type/reversed-V-type that is made by processing a shape of a steel wire plated with zinc or a stainless steel wire having a diameter of 1 millimeter to 6 millimeter and a length of a side of 1 centimeter to 6 centimeter into five sides of an N-shape type, 90 degrees, 80 degrees, 70 degrees, 60 degrees, 50 degrees, 40 degrees, 30 degrees, 20 degrees or 10 degrees and a rotational shaft.

Fifth Embodiment

A three-dimensional N-shape-type/reversed-V-type that is made by processing a shape of a steel wire plated with zinc or a stainless steel wire having a diameter of 1 millimeter to 6 millimeter and a length of a side of 1 centimeter to 6 centimeter into six sides of an N-shape type, 90 degrees, 80 degrees, 70 degrees, 60 degrees, 50 degrees, 40 degrees, 30 degrees, 20 degrees or 10 degrees and a rotational shaft.

Sixth Embodiment

A three-dimensional W-shape-type/I-type that is made by processing a shape of a steel wire plated with zinc or a stainless steel wire having a diameter of 1 millimeter to 6 millimeter and a length of a side of 1 centimeter to 6 centimeter into six sides of a W-shape type, 90 degrees, 80 degrees, 70 degrees, 60 degrees, 50 degrees, 40 degrees, 30 degrees, 20 degrees or 10 degrees and a rotational shaft.

Seventh Embodiment

A three-dimensional W-shape-type/reversed-V-type that is made by processing a shape of a steel wire plated with zinc or a stainless steel wire having a diameter of 1 millimeter to 6 millimeter and a length of a side of 1 centimeter to 6 centimeter into six sides of a W-shape type, 90 degrees, 80 degrees, 70 degrees, 60 degrees, 50 degrees, 40 degrees, 30 degrees, 20 degrees or 10 degrees and a rotational shaft.

Eighth Embodiment

A three-dimensional S-shape-type/reversed-V-type that is made by processing a shape of a steel wire plated with zinc or a stainless steel wire having a diameter of 1 millimeter to 6 millimeter and a length of a side of 1 centimeter to 6 centimeter into three sides of an S-shape type, 90 degrees, 80 degrees, 70 degrees, 60 degrees, 50 degrees, 40 degrees, 30 degrees, 20 degrees or 10 degrees and a rotational shaft.

Ninth Embodiment

A three-dimensional S-shape-type/reversed-W-type that is made by processing a shape of a steel wire plated with zinc or a stainless steel wire having a diameter of 1 millimeter to 6 millimeter and a length of a side of 1 centimeter to 6 centimeter into three sides of an S-shape type, 90 degrees, 80 degrees, 70 degrees, 60 degrees, 50 degrees, 40 degrees, 30 degrees, 20 degrees or 10 degrees and a rotational shaft.

Tenth Embodiment

A curled, waved (circular machining) three-dimensional metal reinforcing aggregate characterized by comprising a three-dimensional concentric true-circular-shape-type/vertical-circle-crossing-type that is made by processing a shape of a steel wire plated with zinc or a stainless steel wire having a diameter of 1 millimeter to 6 millimeter and a length of a side of 1 centimeter to 6 centimeter into a concentric true circle type, 90 degrees, 80 degrees, 70 degrees, 60 degrees, 50 degrees, 40 degrees, 30 degrees, 20 degrees or 10 degrees and a rotational shaft.

Eleventh Embodiment

A three-dimensional two-axis circular-type/vertical-circle-crossing-type that is made by processing a shape of a steel wire plated with zinc or a stainless steel wire having a diameter of 1 millimeter to 6 millimeter and a length of a side of 1 centimeter to 6 centimeter into a two-axis circle type, 90 degrees, 80 degrees, 70 degrees, 60 degrees, 50 degrees, 40 degrees, 30 degrees, 20 degrees or 10 degrees and a rotational shaft.

The three-dimensional metal reinforcing aggregate of the present invention is composed of a bar-shaped metal or an irregular-shaped metal plating or a coated metal.

A proportion of a thickness, a length, an x-axis dimension, a y-axis dimension and a z-axis dimension is properly selected in accordance with an object of use in constructing a concrete structure.

A bending inclination angle of the above-mentioned three-dimensional metal reinforcing aggregate is preferably 30 degrees, 40 degrees, 50 degrees, 60 degrees, 70 degrees, 80 degrees or 90 degrees. The three-dimensional metal reinforcing aggregate is characterized in the curled and/or waved shape. If the value of the first embodiment to the eleventh embodiment is selected in accordance with an object of use, better performance and effects are obtained.

Effects of the Invention

The concrete body using the three-dimensional metal reinforcing aggregate of the present invention has the following advantageous effects.

(1) It can construct a reinforced concrete structure without any necessity of a reinforcing bar arrangement.

(2) It can be placed by a mobile concrete pump. (reinforced concrete)

(3) Since it is a three-dimensional metal reinforcing aggregate, it can be mixed and kneaded uniformly in the concrete body.

(4) Since the concrete body has an even heat conduction, it can prevent degradation.

(5) The aggregate and the aggregate are connected and coupled with the three-dimensional metal reinforcing aggregate, so that it can prevent splitting and cracking as well as drop of concrete lumps.

(6) It has higher internal pressure, external pressure and tensile strength in comparison with the conventional concrete.

(7) It can prevent drop of the concrete lumps at the cold joints caused in execution of works of public works and buildings, especially, the tunnel structures.

(8) It has a strength superior to that of common reinforced concrete./

(9) A concrete body that is strong in shocks can be manufactured.

(10) It can enhance the strength, hardness, internal pressure, external pressure and tensile strength without necessity of a reinforcing bar arrangement.

(11) Since it is a three-dimensional metal reinforcing aggregate of a curled and/or waved shape, it has absorbing ability of electromagnetic waves and is a shielding aggregate for electromagnetic waves.

(12) When it is used in combination with common reinforced concrete, a stronger concrete body can be manufactured, so that it can construct structures of public works and buildings such as tunnels, dams, bridges, airports, harbors and so on.

(13) Since it becomes a concrete body of high strength, it can decrease a volume of the concrete. (It can be placed even in a thin mold.)

### BRIEF DESCRIPTION OF THE DRAWINGS

FIG. 1 is a drawing of a rotating-shaped shaft relating to manufacturing of a three-dimensional metal reinforcing aggregate of the present invention, and has a plan view, an elevation and a side view.

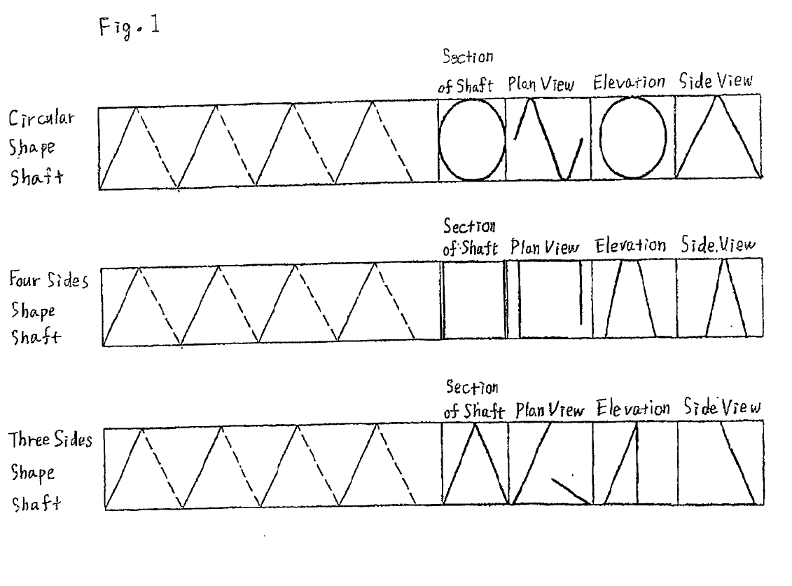

FIG. 2 is a cross-sectional view of a cut concrete body using a three-dimensional metal reinforcing aggregate (three sides processing) of the present invention.

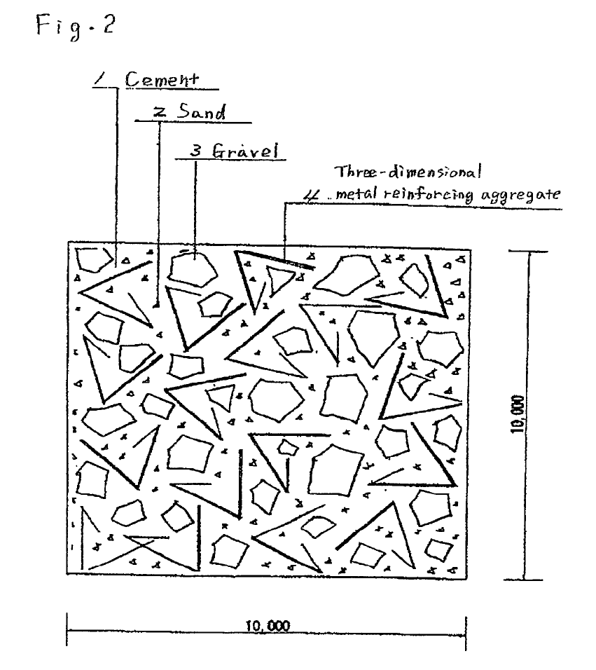

FIG. 3 is a cross-sectional view of a cut concrete body using a three-dimensional metal reinforcing aggregate (circular processing, curl processing and waving processing) of the present invention.

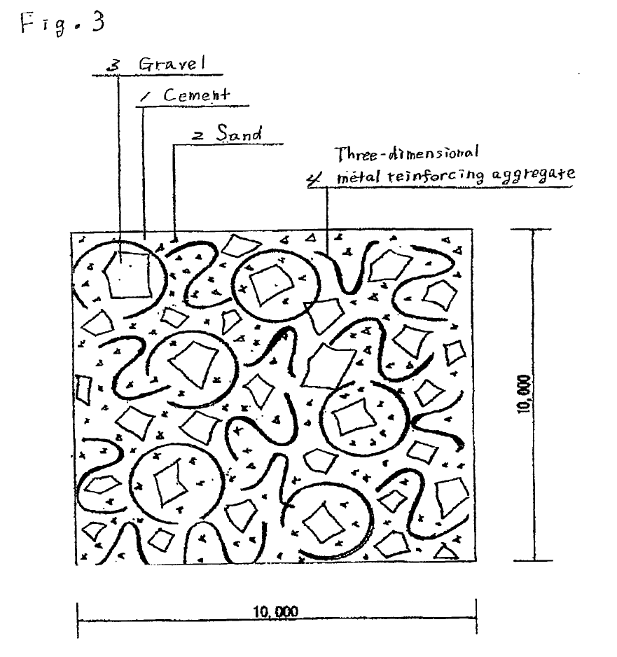

FIG. 4 is a drawing showing a plan of a two sides processing, a three sides processing, four sides processing and a circular processing of a three-dimensional metal reinforcing aggregate of the present invention, is a drawing showing an angle of a winding processing, is a drawing showing a cutting interval in manufacturing a three-dimensional metal reinforcing aggregate and can provide many sides processing.

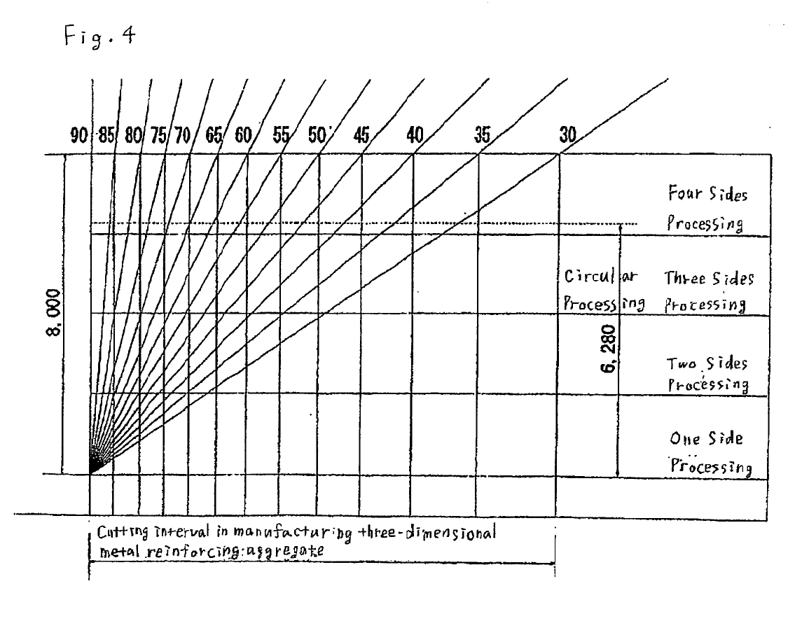

FIG. 5 is a photograph in place of a drawing of a three-dimensional metal reinforcing aggregate of the present invention.

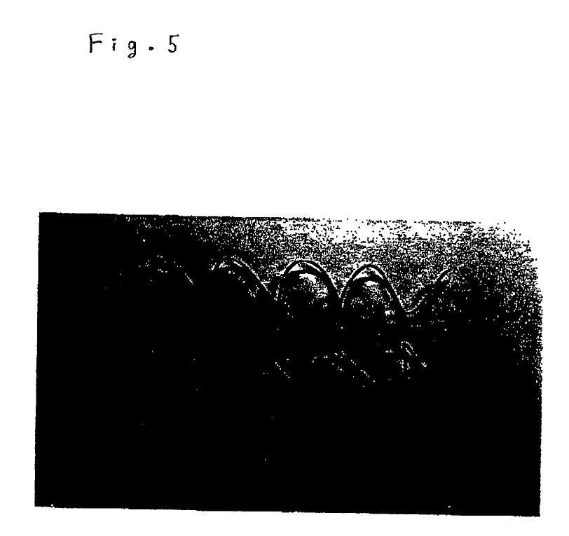

FIG. 6 is a photograph in place of a drawing of a three-dimensional metal reinforcing aggregate of the present invention.

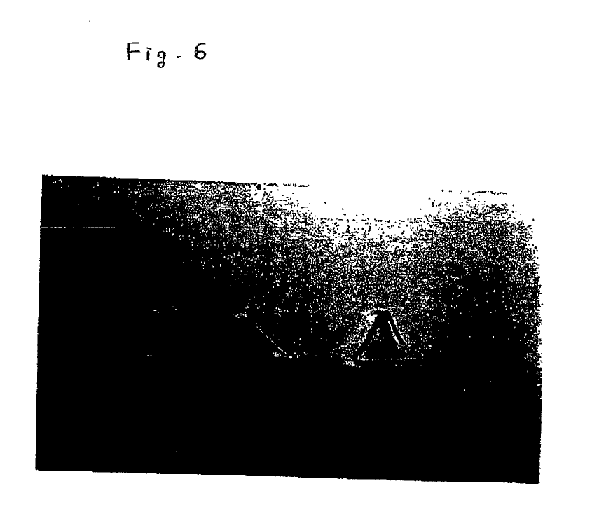

DESCRIPTION OF CODES

1 cement
2 sand
3 gravel
4 three-dimensional metal reinforcing aggregate

1. A three-dimensional metal reinforcing aggregate earthquake resisting concrete characterized by using and mixing and kneading a three-dimensional metal reinforcing aggregate having an x-axis dimension, a y-axis dimension and a z-axis dimension as an aggregate in manufacturing a ready-mixed concrete.

2. A three-dimensional metal reinforcing aggregate mortar using a three-dimensional metal reinforcing aggregate having an x-axis dimension, a y-axis dimension and a z-axis dimension in mixing and kneading a mortar.

3. An earthquake resisting concrete body and an earthquake resisting mortar concrete body using the three-dimensional metal reinforcing aggregate in claim 1 or claim 2.

4. A metal of a three-dimensional metal reinforcing aggregate in claim 1 or claim 2 using a variety of metals, alloys or plated metals, a diameter and a length of the metal corresponding to an object of use.

5. A curled and/or waved three-dimensional metal reinforcing aggregate characterized in that the three-dimensional metal reinforcing aggregate is obtained by processing while adjusting a winding inclination angle of a rotating-shaped shaft, or by another mechanical shaping.

6. The three-dimensional metal reinforcing aggregate being a metal aggregate that can be mixed and kneaded in a gypsum, a resin, a pulp, a rubber, a polyethylene, a plastic and the like and that enhances a strength, a hardness, an internal pressure, an external pressure and a tensile strength.

7. An electromagnetic wave absorbing aggregate characterized by the three-dimensional metal reinforcing aggregate having a three-dimensional shape of a curled and/or waved shape or the like.
